(19) United States
(12) Patent Application Publication
(10) Pub. No.: US 2008/0235185 A1
(43) Pub. Date: Sep. 25, 2008

(54) COMMUNICATION SYSTEM AND METHOD OF ACCESSING THEREFOR

(75) Inventors: Marco Fratti, Saint Germain en Laye (FR); Dragan M. Boscovic, South Barrington, IL (US); Rajesh Tyagi, Ayer, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/688,970

(22) Filed: Mar. 21, 2007

(51) Int. Cl. G06F 17/30

(52) U.S. Cl. 707/3; 707/10; 707/E17.014; 707/E17.107

(57) ABSTRACT

A communication system comprises a user equipment which may access a network via an access network element. Initially, the user equipment transmits a query message to a default network entry point which then contacts a home registration server for the user equipment. The home registration server determines an access network element determination server associated with a current location of the user equipment. The user equipment is informed of the access network element determination server and contacts this. In response, the access network element determination server determines a list of access network elements for the user equipment and transmits the list to the user equipment. The user equipment then registers for a communication service by accessing the network using a selected access network element selected from the list of access network elements. The invention may be particular suitable for accessing an IP Multimedia Subsystem (IMS) via a Customer Premises Equipment (CPE).

### FIELD OF THE INVENTION

The invention relates to a communication system and a method of accessing therefor and in particular, but not exclusively to a communication system comprising an Internet Protocol (IP) Multimedia Subsystem (IMS).

### BACKGROUND OF THE INVENTION

In the future evolution of cellular communication systems, it is expected that these will increasingly be based on Internet Protocol (IP) traffic. For example, it is envisaged that a substantial part of the voice communication will be supported by Voice over IP (VoIP) traffic in the future. Accordingly, the 3^{rd} Generation Partnership Project (3GPP), which is responsible for standardising the 3^{rd} Generation cellular communication systems, has introduced a network architecture which supports IP traffic. This architecture is compatible with and supplements the traditional network architecture and is known as the IP Multimedia Subsystem (IMS).

The aim of IMS is not only to provide new services but to provide all the services, current and future, that the Internet provides. In addition, users have to be able to execute all their services when roaming as well as from their home networks. To achieve these goals, IMS uses open standard IP protocols, defined by the Internet Engineering Task Force (IETF). So, a multimedia session between two IMS users, between an IMS user and a user on the Internet, and between two users on the Internet is established using exactly the same protocol.

In particular, IMS uses a VoIP implementation based on a 3GPP standardised implementation of the Session Initiation Protocol (SIP) and runs over the standard Internet Protocol. Existing phone systems (both packet-switched and circuit-switched) are supported.

SIP is a standard for initiating, modifying, and terminating an interactive user session that involves multimedia elements such as video, voice, instant messaging, online games, and virtual reality. SIP is only used in setting up and tearing down voice or video calls. All voice/video communications are done over the Real-time Transport Protocol (RTP).

IMS supports functionality for managing and controlling subscription information for the users of the system. Specifically, an IMS network comprises a Home Subscriber Server (HSS) which is a master user database that supports the IMS network entities that are actually handling the calls/sessions. These entities comprise the so-called Call Server Control Function (CSCF) elements. A CSCF also acts as a SIP Registrar and stores registration information (such as public identity, private identity, contacts [the IP address of a device, capabilities]). It contains the subscription-related information (user profiles), performs authentication and authorization of the user, and can provide information about the physical location of a user. An HSS may in many scenarios be considered to provide functionality equivalent to a GSM Home Location Register (HLR) and Authentication Center (AuC).

Similarly to other proposed IP multimedia solutions, the IMS network architecture and approach is highly centralized. For example, a centralized application server is used to provide suitable interfaces (Application Programming Interfaces-APIs) for 3^{rd} party application developers, a centralized network service platform is used for providing the necessary network services for running the applications (e.g. presence, authentication, mobility, etc.) and centralized session controllers are used for session origination/modification/termination, quality of service control, charging data records, etc.

However, although a communication system based on an IMS framework may provide efficient performance in many scenarios, it is also associated with a number of disadvantages.

For example, introduction of IMS to a legacy network can be relatively complex and expensive. Specifically, the IMS functions strongly impact existing core network elements and the user equipments. Accordingly, an IMS system requires that a massive simultaneous upgrade of several service-based and connectivity-based modules must be performed.

Also, as IMS was originally introduced as an application support framework for UMTS, the adaptation to different access networks tends to be relatively difficult, especially for wired access networks.

Furthermore, IMS is intrinsically a centralized solution with a number of disadvantages typical of centralized networks. For example, coverage, scalability and management flexibility, efficiency and complexity tend to be suboptimal.

A particular problem for IMS is how to efficiently support small cells and low resource access network elements such as residential access network elements and other Customer Premises Equipment (CPE). For example, there is a current trend towards introducing a large number of picocells to 3G cellular systems. For example, it is envisaged that residential access points may be deployed having only a target coverage area of a single residential dwelling or house and being associated with only one or very few users.

It is often advantageous to decentralise some functionality as this may facilitate development and management of the networks. Especially a more decentralised management of e.g. residential access points and CPEs can be advantageous but faces the associated problem of how to maintain a high degree of reliability and security. For example, a roaming user equipment may preferentially access IMS services via local CPEs but this requires an efficient approach for identifying a suitable CPE and for providing a secure access and registration for the user equipment and the CPE.

Hence, an improved system would be advantageous and in particular a system allowing increased flexibility, facilitated implementation, facilitated operation and/or management, reduced complexity, improved roaming performance, reduced centralisation, secure access, reliable registration and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a method of accessing a network by a user equipment, the method comprising: a user equipment transmitting a first query message to a default network entry point associated with a communication service; the default network entry point transmitting a second query message to a home registration server for the user equipment in response to receiving the first query message; determining an access network element determination server associated with a current location of the user equipment; transmitting a server indication message to the user equipment, the server indication message comprising an indication of the access network element determination server; the user equipment transmitting an access network element request to the access network element determination server in response to receiving the indication of the access network element determination server; the access network element determination server determining a list of access network elements for the user equipment in response to receiving the access network element request; the access network element determination server transmitting the list to the user equipment; and the user equipment registering for the communication service by accessing the network using a selected access network element selected from the list of access network elements.

The invention may allow improved discovery and/or registration in a communication system. An increased decentralisation may be achieved in many embodiments allowing facilitated operational management and/or reduced cost of entry. A reliable and secure discovery and registration for a user equipment may be achieved with improved mobility support.

Specifically, the invention may in many embodiments provide an efficient, reliable and secure network without requiring full centralisation and with efficient mobility support.

The approach may specifically be compatible with existing centralised architecture approaches, such as an IMS network architecture. Specifically, the authentication of an access network element and/or a user equipment may be performed in response to an authentication data exchange with a central home registration server which specifically may be an IMS authentication server.

The access network element may be an access network element of an IMS network and may specifically be a Customer Premises Equipment (CPE) and/or a residential access point with a coverage area of less than, say, 100 meters. The user equipment may for example be an end user terminal, a third generation User Equipment, a mobile station or any other entity capable of accessing the network via the access network element.

The communication service may specifically be an IMS communication service. Some or all of the communication of the user equipment prior to the step of the user equipment registering for a communication service may be supported by other functionality than the access network element. For example, in a cellular communication system, the initial communication may be supported by macro cell base stations until the list of access network elements is received by the user equipment.

The network may be a sub-network of the communication system. For example, a cellular communication system may comprises traditional cellular network functions as well as an IMS sub-network supporting IMS services.

The method may use IP based communication for all or some of the communications.

According to a second aspect of the invention, there is provided a communication system comprising a user equipment accessing a network, at least one default network entry point for the network, a home registration server, at least one access network element determination server and a plurality of access network elements and wherein: the user equipment is arranged to transmit a first query message to a default network entry point associated with a communication service; the network entry point is arranged to transmit a second query message to the home registration server for the user equipment in response to receiving the first query message; the home registration server is arranged to determine an access network element determination server associated with a current location of the user equipment; the home registration server is arranged to cause a server indication message to be transmitted to the user equipment, the server indication message comprising an indication of the access network element determination server; the user equipment is arranged to transmit an access network element request to the access network element determination server in response to receiving the indication of the access network element determination server; the access network element determination server is arranged to determine a list of access network elements for the user equipment in response to receiving the access network element request; the access network element determination server is arranged to transmit the list to the user equipment; and the user equipment is arranged to register for the communication service by accessing the network using a selected access network element selected from the list of access network elements.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates a communication system in accordance with some embodiments of the invention;

FIG. 2 illustrates a discovery and registration approach in accordance with some embodiments of the invention;

FIG. 3 illustrates a message flow in accordance with some embodiments of the invention; and

FIG. 4 illustrates an example of a method of network access in accordance with some embodiments of the invention.

### DETAILED DESCRIPTION OF SOME EMBODIMENTS OF THE INVENTION

The following description focuses on embodiments of the invention applicable to a communication system employing an Internet Protocol Multimedia Subsystem (IMS) network. However, it will be appreciated that the invention is not limited to this application but may be applied to many other communication systems and networks.

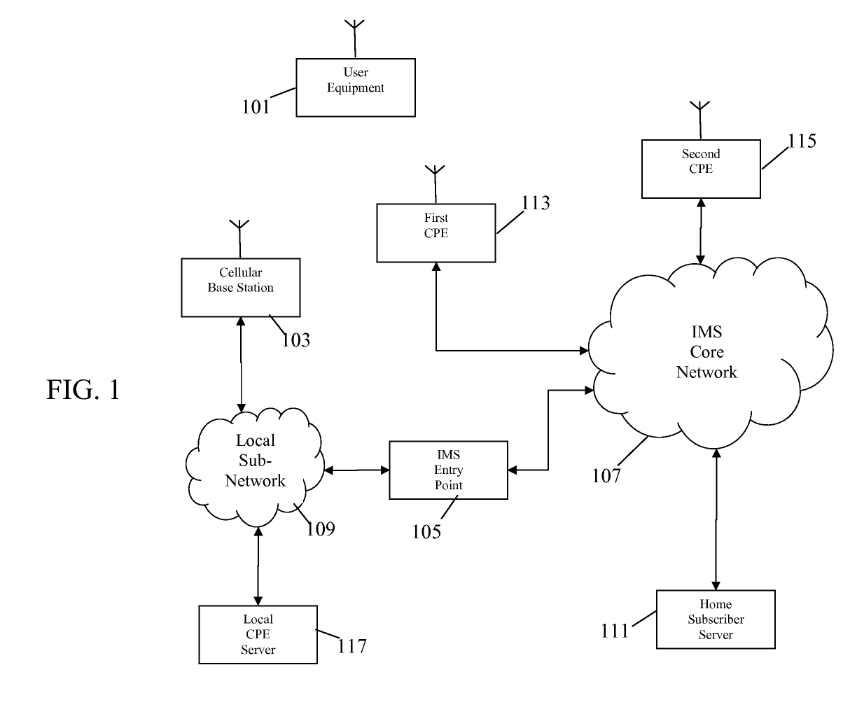

FIG. 1 illustrates a communication system in accordance with some embodiments of the invention. The communication system employs an IMS network which comprises the functionality for providing traditional IMS communication services. Furthermore, the system comprises functionality allowing a distributed deployment of limited resource Customer Premises Equipment (CPE) to be efficiently utilised by roaming user equipments.

The system of FIG. 1 comprises a plurality of user equipments of which only one 101 is shown. The user equipments 101 may communicate with each other or access other available services and applications. Specifically, the user equipment may use IMS communication services supported by the IMS network functionality of the system.

In the example, the communication system is a cellular communication system, such as a UMTS cellular communication system and comprises a number of base stations of which only one 103 is shown.

The user equipment 101 may access communication services of the cellular communication system via the base station 103. Specifically, the user equipment 101 may initiate an IMS communication service by communicating with a IMS entry point linked to the user equipment. In the example, of FIG. 1, the system comprises an IMS entry point 105 which is linked to the subscription of the user of the user equipment 101. Thus, when the user equipment initiates a new IMS registration, it will retrieve the address of the predetermined IMS entry point and transmit a message addressed to this. Thus the user equipment 101 has a specific IMS entry point 105 which is the default entry point for the user equipment accessing the IMS (sub)network of the communication system.

The IMS entry point 105 is coupled to an IMS core network 107 which comprises IMS functionality for routing, addressing, charging etc. in accordance with the specifications of IMS. The IMS entry point 105 is furthermore coupled to the base station 103 via a local sub-network 109 which is arranged to support cellular communications of the base station 103. The local sub-network 109 may for example comprise one or more Radio Network Controllers (RNCs), SGSNs etc.

It will be appreciated that the local sub-network 109 represents network functionality supporting the cellular base station 103 but is not necessarily a physically or logically distinct (sub)network relative to the IMS core network 107. For example, a given network element may be considered to belong to both the local sub network 109 and the IMS core network 107. Specifically, the local sub-network 109 and the IMS core network 107 may be considered to be different representations or aspects of the same common fixed network of the cellular communication system.

The IMS core network 107 is coupled to a central registration server which supports registration and authentication of user equipment accessing the IMS core network 107. In the specific example, the central registration server is an IMS Home Subscription Server (HSS) 111. The HSS 111 comprises the master user database for the IMS network and supports the IMS network entities that are actually handling the calls/sessions. It contains subscription-related information (user profiles), performs authentication and authorization of the user, and can provide information about the physical location of a user. Specifically, the HSS 111 can be considered to include authentication server functionality allowing individual network entities and user equipments to be authenticated.

The system furthermore comprises a number of access network elements 113, 115 which can be used by user equipments 101 to access the IMS network. In the specific example, two access network elements 113, 115 coupled directly to the IMS core network 107 are shown. The access network elements 113, 115 can support the user equipment 101 via communications over the cellular air interface. However, in contrast to the cellular base station 103 which supports a relatively large coverage area (typically more than 1 kilometer), the access network elements 113, 115 support small cells of typically less than 100 meter). Also, the base station 103 is arranged to simultaneously support a large number of users (typically more than twenty) whereas the access network elements 113, 115 only have capability of simultaneously supporting a small number of users (typically less than five).

In the specific example, the two access network elements 113, 115 are Customer Premises Equipment (also sometimes referred to as Customer Provided Equipment) which in the specific example may be located in e.g. an office or an individual subscriber's home. A Customer Premise Equipment (CPE) is generally considered to be any terminal and associated equipment and inside wiring located at a subscriber's premises and connected with a carrier's telecommunication channel(s) at a demarcation point.

The CPEs 113, 115 are illustrated as coupled directly to the IMS core network 107 and may e.g. be coupled to the same IMS border router either by a direct connection or by a logical connection.

In the system of FIG. 1, the CPEs support mobility of the user equipments such that at least some of the CPEs can support IMS communication services not only for user equipments which are associated with the CPE but also for user equipments which temporarily are in the area covered by the CPE. Specifically, a CPE typically has a number of user equipments associated with it, i.e. it is a home CPE for a group of user equipments. A user's home CPE corresponds to the CPE which is the default routing location for the user equipment.

However, as users move, the user equipments may attach to CPEs which are not the home CPE of the user equipments, i.e. they may temporarily be supported by a non-home CPE. In this case, a CPE is said to be a visited or foreign CPE for the user equipment.

The CPEs 113, 115 of the system of FIG. 1 accordingly comprise functionality for managing attachments from both home user equipments as well as visiting user equipments.

The illustrated system comprises functionality for providing improved discovery of CPEs and for improved registration via such CPEs. Specifically, the system enhances traditional IMS networks by providing decentralised functionality for directing user equipments towards specific CPEs that are locally available and are suitable for providing the required IMS service. The system allows for the discovery to be locally managed and specifically allows the information of the available suitable CPEs to be managed and maintained in a decentralised fashion and without requiring such information to necessarily be provided in a central registration server such as the HSS. As a typical system may comprise a dynamically varying and large number of CPEs, a more localised management provides substantial advantages. Furthermore, the system allows the efficient use of CPEs and specifically allows a roaming user equipment to utilise visited or foreign CPEs while at the same time ensuring a reliable authentication and registration.

Specifically, the system of FIG. 1 comprises a number of access network element determination servers each of which is arranged to support a limited area covered by the communication system. The access network element determination servers comprise information related to CPEs within a given limited area and based on this information each access network element determination server can determine a suitable CPE for a user equipment in the area covered by the server. The system of FIG. 1 specifically comprises an access network element determination server, henceforth referred to as a local CPE server 117, which serves a local area comprising the cells supported by the cellular base station 103 and the first and second CPE 113, 115. The local CPE server 117 is coupled to the local sub-network 109 and may specifically be coupled to an SGSN supporting the cellular base station 103.

It will be appreciated that the region supported by each access network element determination server may be different in different embodiments. For example, an access network element determination server may be arranged to support CPEs within an area supported by a one or more RNCs or may e.g. cover a given sub-network supported by a specific network operator.

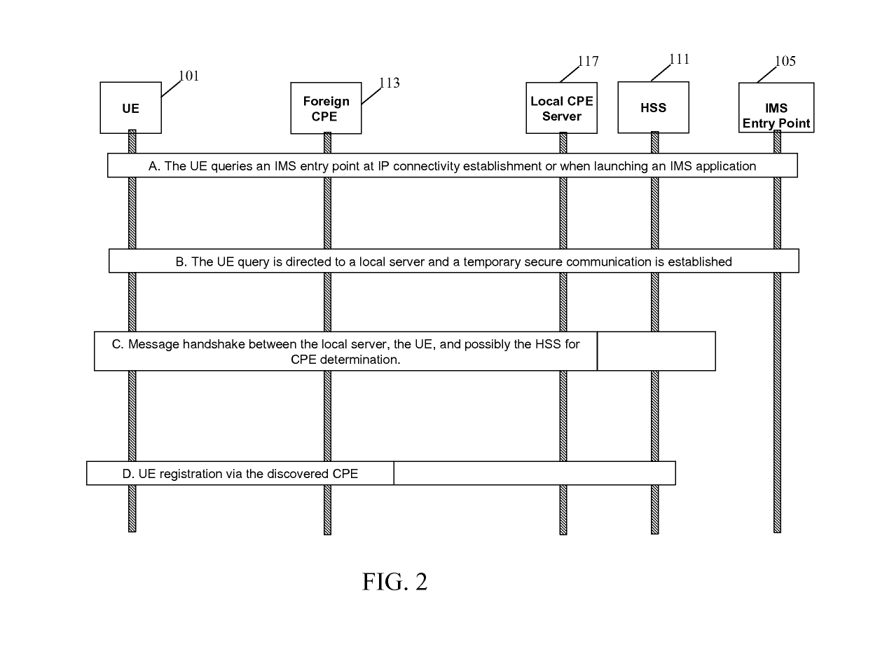

FIG. 2 illustrates the discovery and registration approach used in the system of FIG. 1. In the example, the user equipment 101 is situated close to a first CPE 113 which is not the user equipments home CPE but is a visited CPE.

The discovery and registration approach comprises four main phases. Initially, the user equipment 101 seeking to register with the IMS network transmits a query message to the default IMS entry point 105. For example, the query may be initiated at IP connectivity establishment or when launching an IMS application. The query message results in the user equipment 101 being provided with an address of a local access network element determination server covering the area in which the user equipment 101 is currently located. In the specific example, the user equipment 101 is provided with the address of the local CPE server 117.

In phase B, the user equipment 101 then establishes a secure communication with the local CPE server 117. The local CPE server 117 may be controlled by the subscriber's home IMS service provider thereby allowing the user equipment 101 to discover a CPE in the home domain. Alternatively or additionally, the local CPE server 117 may be controlled by a visited IMS service provider thereby allowing the user equipment 101 to discover a CPE in a visited domain.

In phase C, communication between the user equipment 101 and the local CPE server 117 allows one or more suitable CPEs to be identified by the local CPE server 117 and communicated to the user equipment 101.

In phase D, the user equipment 101 then proceeds to access (one of) the identified CPE(s). Specifically, the user equipment 101 proceeds to perform an IMS registration via a selected CPE 113. This registration process may specifically include authentication of the user equipment 101 and the user thereof by the selected CPE 113 and of the selected CPE 113 by the user equipment 101.

The described approach allows information required for a user equipment to discover suitable CPEs for IMS access to be locally stored and maintained thereby substantially facilitating the management of potentially large and dynamically varying CPE deployments. Furthermore, a low complexity and robust discovery and registration can be achieved while maintaining compatibility with IMS requirements. Also, the approach allows a mobile user equipment to efficiently be directed to a home or visited CPE depending on the current location of the user equipment 101. The system allows any CPE to act as a visited CPE for roaming user equipment. The system furthermore allows efficient direction of user equipments to suitable CPEs thereby providing improved resource utilisation and quality of service. Specifically, detailed location and local information can be used to select the appropriate CPE without requiring a centralised gathering of such information.

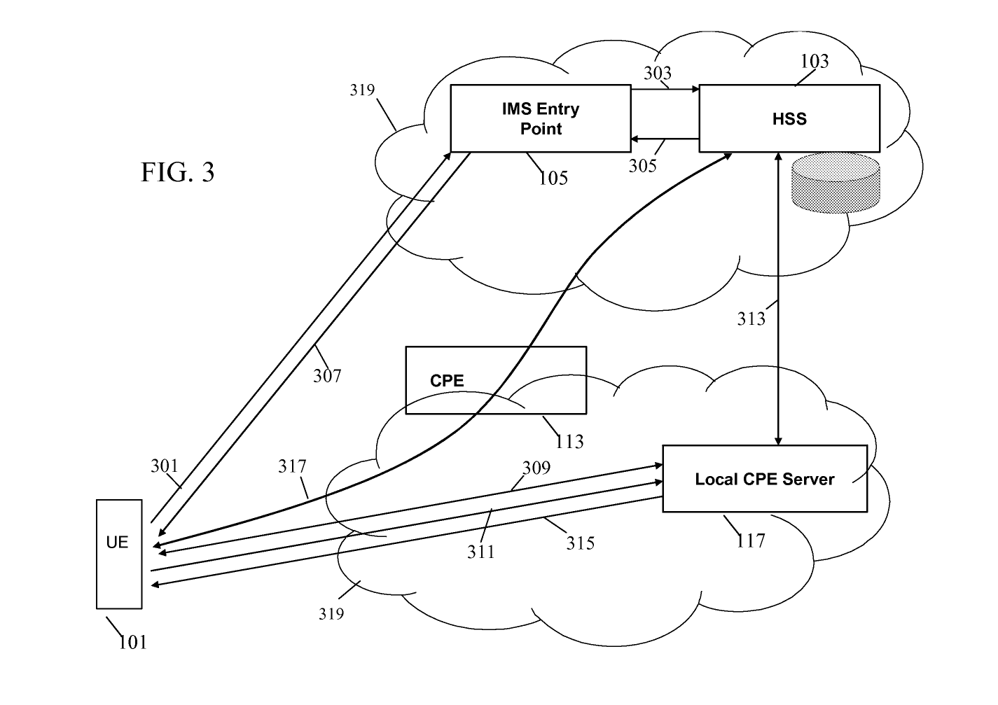

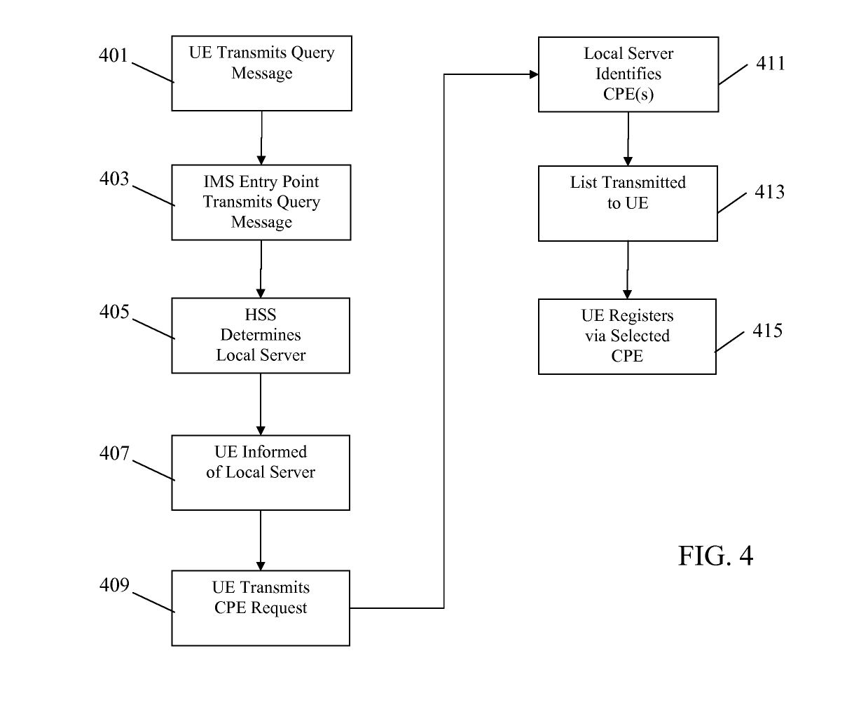

In the following, a specific example of the operation of the system of FIG. 1 will be described with reference to FIG. 3 and FIG. 4 wherein FIG. 3 illustrates a message flow in the system of FIG. 1 and FIG. 4 illustrates an example of a method of operation for the system of FIG. 1.

The exemplary method initiates in step 401 wherein the user equipment 101 transmits a first query message to the default IMS network entry point 105 associated with a communication service desired by the user equipment 101. The message flow is indicated by arrow 301 of FIG. 3.

The IMS entry point may specifically be a fixed default predetermined entry point which is linked to a subscription identity of the user equipment 101. Specifically, the user equipment 101 may be arranged to retrieve information of the default IMS entry point from a removable Subscriber Identity Module (SIM). Thus, the SIM card of the user equipment 101 may comprise an explicit address of an IMS entry point 105 and whenever the user equipment 101 initiates an IMS registration, it will first access this entry point 105 and will specifically send a query message to the identified entry point 105.

In the example, the address is provided as a Uniform Resource Locator (URL), such as “IMS_provider-name.com”. The routing of this message may be performed by accessing a Domain Name Server, DNS, to find the specific network address associated with the URL.

The query message may specifically be communicated in accordance with IP techniques.

The query message may be any message which indicates that the user equipment 101 should be provided with an address of a local CPE server. In the specific example, the first query message transmitted by the user equipment 101 may be a Packet Data Protocol (PDP) session setup message (e.g. an additional query message part may be embedded in a PDP sessions setup message).

As as specific example the user equipment 101 can query a “Tier 0 DNS” for the IMS entry point address where tier 0 may correspond to a root DNS server and the top level domain “IMS_provider-name.com”.

The user equipment 101 can then send an Activate PDP Context Request message to the IMS entry point 105 (e.g. implemented in an SGSN). The PDP Context Request message may e.g. comprise the following information data: Network layer Service Access Point Identifier (NSAPI), Tunnel Identifier (TI), PDP Type, PDP Address, Access Point Name, Quality of Service, Common Information Elements, Other Information Elements.

The Other Information Elements data segment may include a Protocol Configurations Options data in order to transfer external network protocol options associated with the PDP context activation.

In the example, the query message comprises an indication of a current location of the user equipment 101. This location indication may be a specific and relatively accurate location estimate determined by the user equipment 101 (e.g. by a GPS receiver located in the user equipment 101) or by the cellular network (e.g. by triangulation between base stations) or may be a coarse location indication given for example by an indication of the current cell serving the user equipment 101. As another example, the location indication may be provided by Location Area Information, LAI, data included in the message.

Step 401 is followed by step 403 wherein the IMS entry point 105 transmits a second query message to the HSS 111 in response to receiving the first query message. The message flow is indicated by arrow 303 of FIG. 3.

The second message may be identical to the first query message received from the user equipment 101 or may be a message embedding the first message. Thus, in some embodiments the IMS entry point 105 may simply forward the message to the HSS 111.

Similarly to the first message, the second message will comprise location data for the user equipment 101 thereby allowing the HSS 111 to identify a suitable local CPE server for the current location of the user equipment 101.

Step 403 is followed by step 405 wherein the HSS 111 determines an access network element determination server associated with a current location of the user equipment 101. In the specific example, the HSS 111 identifies that the local CPE server 117 is associated with the CPEs 113, 115 which reside in the area in which the user equipment 101 currently is.

Specifically, the HSS can compare the received location data to a list of regions covered by each local CPE server and can select the one covering the current region of the user equipment 101.

Step 405 is followed by step 407 wherein a server indication message is transmitted to the user equipment 101 where the server indication message comprises an indication of the identified access network element determination server, i.e. of the local CPE server 117.

In the example of FIG. 1, the HSS 111 first transmits a message to the IMS entry point 105 which then transmits an indication message to the user equipment 101. Thus, as illustrated by arrows 305 and 307 of FIG. 3, a message flow is generated that provides the user equipment 101 with information of the identity of the local CPE server 117.

In the specific example, the message from the IMS entry point 105 to the user equipment 101 may be (embedded in) a Packet Data Protocol session setup message. Specifically, the IMS entry point 105 can create and transmit a PDP Context Response message which is transmitted to the user equipment 101. This message can comprise information of the local CPE server 117 e.g. by including information in a Protocol Configurations Options field of the PDP Context Response message. Specifically, the indication can comprise an indication of the URL of the local CPE server 117 and may specifically be preceded by “https” to indicate that a secure communication should be established with the local CPE server 117.

Step 407 is followed by step 409 wherein the user equipment 101 receives the indication of the local CPE server 117 and in response transmits an access network element request to the local CPE server.

Specifically, when the user equipment 101 receives the message from the IMS entry point 105, it proceeds to initiate a handshake exchange of messages with the local CPE server 117 in order to setup a secure communication between these. In the example, the user equipment 101 and local CPE server 117 use a secure communication protocol in the form of the Hyper Text Transfer Protocol Secure (HTTPS) communication protocol. The communication may be established by a Secure Sockets Layer (SSL) handshake protocol which allows the user equipment 101 and local CPE server 117 to authenticate each other and to negotiate an encryption and MAC (Message Authentication Code) algorithm and cryptographic keys to be used to protect the data sent in the SSL record. This setup is indicated by arrow 309 in FIG. 3.

The user equipment 101 then requests data indicating a suitable CPE as illustrated by arrow 311 in FIG. 3.

Step 409 is followed by step 411 wherein the local CPE server 117 determines a list of access network elements (CPEs) which are suitable for the user equipment 101. It will be appreciated that in some scenarios/embodiments only a single CPE is identified whereas in other scenarios/embodiments two or more possible CPEs may be included in the list. Thus it will be appreciated that the list may comprise one or more CPEs.

As a first step, the local CPE server 117 authenticates the user equipment 101 using information obtained from the HSS 111. Specifically, when the local CPE server 117 receives a message from the user equipment 101, it proceeds to contact the HSS 111 to retrieve specific information for that user equipment 101. For example, the local CPE server 117 can retrieve a public key which can be used to verify a signature used by the user equipment 101 when transmitting the message. This communication is indicated by arrow 313 of FIG. 3.

The local CPE server 117 can determine a list of suitable CPEs in response to any suitable criterion or algorithm.

For example, the local CPE server 117 can determine the list of CPEs in response to location data for the user equipment. E.g., the local CPE server 117 can comprise a database which includes the location of a number of CPEs in the region covered by the local CPE server 117. The request message from the user equipment 101 can comprise a location estimate which can be compared to the locations of the CPEs. In a simple embodiment, the closest CPE may be identified and returned to the user equipment 101. As another example, the local CPE server 117 may impose the criterion that suitable CPEs should be selected from those CPEs which are less than a certain distance from the user equipment 101.

Alternatively or additionally, the local CPE server 117 can determine the list of CPEs in response to communication service subscription data for the user equipment 101. For example, depending on the services that are subscribed to, the local CPE server 117 may limit the set of potential CPEs to only those CPEs which can provide such services. Also, in some cases different CPEs may be used by different users and this can be taken into account by the local CPE server 117.

Alternatively or additionally, the local CPE server 117 can determine the list of CPEs in response to a capability of the CPEs to support a requested communication service for the user equipment. For example, if a high data rate video service is requested, the local CPE server 117 may only consider CPEs which are capable of supporting such a service. The local CPE server 117 may consider the inherent capabilities of the CPEs, such as the ability to support a given modulation scheme and/or may consider dynamic fluctuating capabilities such as the current available resource. Thus, the evaluation of the CPE capability can include a consideration of available resources in the wireless or wired interfaces of the CPE, or e.g. available computational power/memory inside the CPE etc.

In the system of FIG. 1, the local CPE server 117 is furthermore arranged to determine the list of CPEs in response to data retrieved from the HSS 111. Thus, the local CPE server 117 may send a request to the HSS 111 identifying the user equipment 101 and may in response receive e.g. subscription information, CPE location information etc (as indicated by arrow 313 in FIG. 3).

For example, in some embodiments the static information of the CPEs such as their public key, location, inherent capability etc are stored at the HSS 111 and retrieved therefrom. For example, the local CPE server 117 can request an indication of all CPEs in the vicinity of the user equipment 101.

The local CPE server 117 may then proceed to locally determine the current dynamic resource availability for each of the identified CPEs and select the CPE meeting a combined proximity and resource availability criterion.

Step 411 is followed by step 413 wherein the local CPE server 117 transmits a message with an indication of the identified CPE(s) to the user equipment 101 as indicated by arrow 315 of FIG. 3.

Step 413 is followed by step 415 wherein the user equipment 101 proceeds to register for an IMS communication service by accessing the network using a CPE which is selected from the list of CPEs received from the local CPE server 117. Specifically, if the list comprises only a single CPE 113, the user equipment 101 transmits an attach message to this CPE 113 thereby initiating a registration procedure.

Thus, the user equipment 101 can register to the IMS network using the intermediary of the discovered CPE 113. This registration may specifically include the steps of a conventional IMS registration e.g. in accordance with the specifications of the 3^{rd} Generation Partnership Project. However, rather than performing such a registration via the IMS entry point 105 it is performed via the selected CPE 113. Specifically, the selected CPE 113 can comprise a functional entity that performs the functionality of an IMS Proxy Call Session Control Function (P-CSCF). The registration of the user equipment 101 is indicated by arrow 317 of FIG. 3.

In addition to performing conventional registration steps, the registration furthermore comprises an authentication of the selected CPE 113 and the user equipment 101 by each other. Thus, the user equipment 101 performs an authentication of the selected CPE 113 to ensure that the selected CPE 113 is a valid entry point and the selected CPE 113 performs an authentication of the user equipment 101 in order to ensure that this is a valid user equipment 101. The authentication can specifically be performed by a retrieval of public keys from the HSS 111 followed by independent verifications of signatures provided by the other entity.

Also, in the specific example, the selected CPE 113 not only authenticates the user equipment 101 but also performs a user authentication of the subscriber of the user equipment 101. For example, the user equipment 101 may retrieve a signature from the SIM card of the user equipment 101 and transmit this to the selected CPE 113 which may use a public key obtained from the HSS 111 to verify it.

In the system, the registration of the user equipment 101 proceeds only if all authentications are successful.

The described system thus provides efficient, reliable and secure discovery and registration in a system wherein a large number of CPEs may be deployed. The system allows the existing centralised IMS approach to be combined with a decentralised discovery and registration approach which is suitable for dynamically changing systems with many possible network access points.

Also, the system provides for efficient operation in systems where a user equipment is not restricted to only using a home CPE. Rather, the system allows efficient discovery of foreign CPEs and allows reliable registration via such CPEs. For example, as illustrated in FIG. 3, a visited domain 317 comprising the selected CPE 113 and the local CPE server 117 may effectively interwork with the user equipment's 101 home domain 319 comprising the IMS entry point 105 and the HSS 111 to provide support for a roaming user equipment 101.

Also, in some embodiments, the provider of IP connectivity used for the discovery of the CPE may also be the IMS service provider. In this case, the IMS entry point identifier may be stored in a memory that is readable by the user equipment 101 (e.g. the SIM card). In such an example, the query sent to the IMS entry point may be automatically transmitted at PDP Context Request initiation.

However, in other embodiments, the IMS service provider is not the provider of the IP connectivity used for the discovery. For instance, the IMS subscriber can purchase a specific application client that is responsible for the registration operations and for the IMS service consumption. In this case, the CPE discovery operations may be initiated by the initiation of an application using the IMS communication service.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of accessing a network by a user equipment, the method comprising:
a user equipment transmitting a first query message to a default network entry point associated with a communication service;
the default network entry point transmitting a second query message to a home registration server for the user equipment in response to receiving the first query message;
determining an access network element determination server associated with a current location of the user equipment;
transmitting a server indication message to the user equipment, the server indication message comprising an indication of the access network element determination server;
the user equipment transmitting an access network element request to the access network element determination server in response to receiving the indication of the access network element determination server;
the access network element determination server determining a list of access network elements for the user equipment in response to receiving the access network element request;
the access network element determination server transmitting the list to the user equipment; and
the user equipment registering for the communication service by accessing the network using a selected access network element selected from the list of access network elements.

2. The method of claim 1 wherein the step of transmitting a server indication message to the user equipment comprises the home registration server transmitting a first indication message to the default network entry point and the default network entry point transmitting a second indication message to the user equipment, the first and second indication messages comprising an indication of the access network element determination server.

3. The method of claim 1 wherein the first and second query messages comprise location data for the user equipment.

4. The method of claim 1 wherein the first query message is routed to the network entry point in response to address information from a Domain Name Server, DNS.

5. The method of claim 1 further comprising the user equipment retrieving address information for the default network entry point from a removable Subscriber Identity Module, SIM.

6. The method of claim 1 wherein the first server indication message is a Packet Data Protocol session setup message.

7. The method of claim 1 wherein the first query message is a Packet Data Protocol session setup message.

8. The method of claim 1 wherein the home registration server determines the access network element determination server in response to a location data for the user equipment.

9. The method of claim 1 wherein the user equipment and the access network element determination server communicate using a secure communication protocol.

10. The method of claim 9 wherein the access network element determination server authenticates the user equipment before transmitting the list of access network elements to the user equipment.

11. The method of claim 10 wherein the access network element determination server authenticates the user equipment in response to data received from the home registration server.

12. The method of claim 1 wherein the access network element determination server determines the list of access network elements in response to data retrieved from the home registration server in response to receiving the access network element request.

13. The method of claim 1 wherein the access network element determination server determines the list of access network elements in response to location data for the user equipment.

14. The method of claim 1 wherein the access network element determination server determines the list of access network elements in response to communication service subscription data for the user equipment.

15. The method of claim 1 wherein the access network element determination server determines the list of access network elements in response to a capability of access network elements to support the communication service.

16. The method of claim 1 wherein the step of the user equipment registering for the communication server comprises the user equipment authenticating the selected access network element.

17. The method of claim 1 wherein the step of the user equipment registering for the communication server comprises the selected access network element authenticating the user equipment.

18. The method of claim 1 wherein the step of the user equipment registering for the communication server comprises the selected access network element performing a subscriber authentication for a user of the user equipment.

19. The method of claim 1 wherein the communication service is an Internet Protocol, Multimedia Subsystem, IMS service.

20. A communication system comprising a user equipment accessing a network, at least one default network entry point for the network, a home registration server, at least one access network element determination server and a plurality of access network elements and wherein:
the user equipment is arranged to transmit a first query message to a default network entry point associated with a communication service;
the network entry point is arranged to transmit a second query message to the home registration server for the user equipment in response to receiving the first query message;
the home registration server is arranged to determine an access network element determination server associated with a current location of the user equipment;
the home registration server is arranged to cause a server indication message to be transmitted to the user equipment, the server indication message comprising an indication of the access network element determination server;
the user equipment is arranged to transmit an access network element request to the access network element determination server in response to receiving the indication of the access network element determination server;
the access network element determination server is arranged to determine a list of access network elements for the user equipment in response to receiving the access network element request;
the access network element determination server is arranged to transmit the list to the user equipment; and
the user equipment is arranged to register for the communication service by accessing the network using a selected access network element selected from the list of access network elements.
